(19) United States
(12) Patent Application Publication
(10) Pub. No.: US 2022/0403866 A1
(43) Pub. Date: Dec. 22, 2022

(54) PRE-FIXING TWO SUBSTRATES

(71) Applicant: SIKA TECHNOLOGY AG, Baar (CH)

(72) Inventor: Noah MUNZINGER, Zürich (CH)

(73) Assignee: SIKA TECHNOLOGY AG, Baar (CH)

(21) Appl. No.: 17/777,378

(22) PCT Filed: Dec. 11, 2020
(86) PCT No.: PCT/EP2020/085831

§ 371 Date: May 17, 2022

(30) Foreign Application Priority Data
Dec. 13, 2019 (EP) 19216222.0

(51) Int. Cl. F16B 11/00; F16B 5/08; C09J 5/06; C09J 5/10

(52) U.S. Cl. CPC F16B 11/006; F16B 5/08; C09J 5/06; C09J 5/10

(57) ABSTRACT

A system including two pre-fixed substrates, wherein a first substrate and a second substrate. Each of the substrates has an opening in an overlap region, and an adhesive is arranged between the overlap regions, wherein the adhesive connects the two substrates together and is arranged at least partly in the openings. The adhesive is locally cured in the region of the openings. A cured sub-region of the adhesive extends from the first opening into the second opening, and a second sub-region of the adhesive is not cured.

The present invention relates to a system of two pre-fixed substrates and to a method for pre-fixing two substrates.

In automotive body shell construction, various different bonds between substrates are required. Inter alia, there are adhesive bonds, which are additionally mechanically fixed before the adhesive has cured. Such additional mechanical fixings can be provided, for example, by spot-welding, riveting or clinching. These mechanical fixings serve to hold substrates together before the adhesive is cured in a painting oven.

However, these additional mechanical fixings have the disadvantage that the substrates thereby experience slight damage, which can have a negative impact on the durability of the bond. Accordingly, efforts are made to avoid such mechanical fixings or to replace them with an alternative solution.

In order to achieve this, it has been proposed, inter alia, to dispense with such mechanical pre-fixings and instead to punctually cure the adhesive in order to pre-fix the substrates to be joined. Such punctual curing is intended to achieve sufficiently good pre-fixing to hold the substrates together before the adhesive is cured fully in the painting oven.

Such a system with punctually cured adhesive dots is described, for example, in WO 2018/109045 A1.

However, it has been shown that, in particular, the high-temperature adhesion of such punctually cured adhesive dots is not sufficiently high for many applications. In particular in painting ovens in which temperatures of approximately 180° C. typically prevail, the adhesion to the substrates of such punctually cured adhesive dots is often too low.

There is thus a need to improve adhesive bonds that do not use mechanical pre-fixings, in particular in respect of high-temperature adhesion.

Accordingly, the object underlying the present invention is to provide improved pre-fixing of substrates which are used in particular in automotive body shell construction, wherein on the one hand it is to be possible to dispense with additional mechanical pre-fixings and wherein on the other hand improved high-temperature adhesion is to be ensured. Such a pre-fixing is additionally to be able to be incorporated easily into existing process steps and to be implemented inexpensively.

In order to achieve this object, a system of two pre-fixed substrates is first proposed. This system comprises: a first substrate having a first opening in a first overlap region; a second substrate having a second opening in a second overlap region; and an adhesive which is arranged between the overlap regions of the first substrate and of the second substrate, wherein the adhesive both bonds the substrates together and is arranged at least partly in the openings; wherein the adhesive is locally cured in a region of the openings, wherein a cured first sub-region of the adhesive extends from the first opening into the second opening and wherein a second sub-region of the adhesive is uncured.

The system proposed here first offers the advantage that, by means of the openings in the substrates, improved bonding between the substrate and the adhesive can be achieved. In this case, the adhesive bonds to the substrate also within the opening, whereby an improved connection can be achieved in that different spatial orientations of adhesive surfaces are made possible.

Because the adhesive is locally cured in the region of the openings, a cured sub-region of the adhesive which extends from the opening of one substrate to the opening of the other substrate is formed. Accordingly, a kind of pin or stud is formed, which secures the two substrates against displacement. In tests, it has been possible to show that, by means of such additional anchoring of the cured sub-region of the adhesive in openings of the substrates, substantially better high-temperature adhesion can be achieved than is the case without such openings.

Furthermore, the system proposed here has the advantage that pre-fixing of two joining partners can be ensured without additional mechanical fixings. As a result, there is no undesirable weakening in terms of the strength of the joined joining partners.

A further advantage of the system proposed here is to be seen in that, by the provision of openings, the adhesive is better accessible for local curing. Thus, different curing systems can be used, that is to say, in addition to heat-curable adhesives, it is also possible to use, for example, adhesives which are cured by means of radiation, since the adhesive, unlike in known systems, is accessible from the outside on account of the openings.

In one exemplary embodiment, the first opening and the second opening are arranged so that they overlap at least partly.

In an exemplary further development, the first opening and the second opening are arranged so that they overlap substantially completely.

Such an overlapping or partly overlapping arrangement of the openings has the advantage that as small a portion as possible of the adhesive thus has to be cured in order to develop the desired effect. In the case of complete overlapping, a straight pin or stud can be formed which projects both into the first opening and into the second opening and thus anchors the two substrates together.

In one exemplary embodiment, the width of the overlapping portions is from 5 mm to 40 mm, preferably from 10 mm to 30 mm, particularly preferably from 10 mm to 20 mm.

In one exemplary embodiment, the maximum diameter of the openings, measured at a surface of the substrates that in each case faces away from the other substrate, is from 1 mm to 20 mm, preferably from 2 mm to 10 mm, particularly preferably from 2 mm to 8 mm.

In one exemplary embodiment, the maximum diameter of the openings, measured at a surface of the substrates that in each case faces away from the other substrate, is from 20% to 80%, preferably from 30% to 70%, particularly preferably from 40% to 60% of the width of the overlapping portions.

The mentioned dimensions of the overlapping portions and of the openings have been found to be particularly advantageous in connection with this invention.

In one exemplary embodiment, the openings have a substantially round, oval, rectangular, polygonal or square shape.

In one exemplary embodiment, at least one opening has an undercut, wherein the opening tapers toward a side of the substrate that faces toward the adhesive.

In an exemplary further development, both openings have such an undercut.

The provision of such an undercut offers the advantage that even better mechanical anchoring can thereby be achieved. In this case, the substrates are secured not only against displacement in a plane of the substrates but also against displacement perpendicular to the plane of the substrates.

In one exemplary embodiment, the adhesive completely fills at least one opening.

In an exemplary further development, the adhesive extends beyond the opening at a surface of at least one substrate that faces away from the other substrate.

Such complete filling or overfilling of the openings with adhesive has the advantage that improved mechanical anchoring can be achieved. In particular in the case of slight overfilling of the openings, a similar effect can be achieved as is achievable with the undercut openings. By means of the adhesive that spills out, mechanical anchoring which prevents displacement of the substrates perpendicular to a plane of the substrates is achieved.

In an exemplary further development, the adhesive extends by not more than 5 mm, preferably by not more than 3 mm, particularly preferably by not more than 1 mm beyond the opening on a surface of a substrate that faces away from the other substrate.

In one exemplary embodiment, the first cured sub-region of the adhesive amounts to not more than 30% of the total adhesive volume, preferably not more than 25%, preferably not more than 20%, preferably not more than 15%, particularly preferably not more than 10%.

The smaller the amount of adhesive that must be locally cured in relation to the total adhesive volume, the more efficient and inexpensive such a system can be.

In one exemplary embodiment, the substrates each have a plurality of openings, wherein an opening in the first substrate is in each case associated with an opening in the second substrate.

Depending on the size and nature of the substrates used, a different number of holes per substrate can be chosen.

In an exemplary further development, the openings are arranged in succession in the overlap regions of the substrates. For example, such a series of openings in the substrates can in each case follow an edge of the substrates which forms the termination of the overlap regions.

In one exemplary embodiment, the adhesive is a one-component adhesive.

In one exemplary embodiment, the adhesive is an epoxy-based or polyurethane-based adhesive.

In one exemplary embodiment, the adhesive has a viscosity of 500 to 5000 Pas, preferably of 800 to 4000 Pas, particularly preferably of 1000 Pas to 3500 Pas.

Viscosity measurements of the adhesives were effected 1 d after production on an Anton Paar MCR 101 rheometer by oscillation using a plate-plate geometry at a temperature of 25° C. with the following parameters: 5 Hz frequency, 1 mm gap, 25 mm plate diameter, 1% deformation.

In one exemplary embodiment, the adhesive has a glass transition temperature (Tg) of at least 80° C., preferably of least 100° C., preferably of least 120° C., particularly preferably of least 150° C.

In one exemplary embodiment, the adhesive is a heat-curable adhesive.

In an alternative embodiment, the adhesive is an adhesive curable by radiation, in particular UV radiation.

Generally, adhesives as described in WO 2018/109045 A1 can in particular be used for carrying out this invention.

For example, an adhesive which is marketed by Sika under the trade name SikaPower®-498 can be used for carrying out this invention. A further adhesive which can be used in connection with this invention is marketed by Dow under the trade name Betamate® 1480.

In one exemplary embodiment, the substrates are formed of metal and/or of plastics. In one exemplary embodiment, the substrates are formed of sheet steel or of aluminum sheet. In an alternative exemplary embodiment, the substrates are formed of carbon or of other plastics.

In one exemplary embodiment, the substrates are parts of a body, in particular of a motor vehicle body.

The object stated at the beginning is additionally achieved by a method for pre-fixing two substrates. The method comprises the steps of: providing a first substrate having a first opening in a first overlap region, a second substrate having a second opening in a second overlap region, and an adhesive; arranging the adhesive between the overlap regions of the first substrate and of the second substrate so that the adhesive both bonds the substrates and is arranged at least partly in the openings; and locally curing the adhesive in a region of the openings so that a cured first sub-region of the adhesive is formed which extends from the first opening into the second opening, wherein a second sub-region of the adhesive remains uncured.

In one exemplary embodiment, during the arrangement of the adhesive, the adhesive is first arranged on an overlap region of one substrate and then the other substrate is arranged with its overlap region on the adhesive, and then the two substrates are moved toward one another so that the adhesive is pressed at least partly into the openings.

In one exemplary embodiment, heat or radiation, in particular UV radiation, is applied in the region of the openings during the local curing.

In one exemplary embodiment, the method comprises the further step: coating the substrates before the adhesive is fully cured.

In one exemplary embodiment, the method is carried out using a system according to the description above.

The invention will be explained in greater detail hereinbelow by way of example with reference to schematic drawings.

### THE FIGURES SHOW

FIG. 1a to 1c an example of a system of two pre-fixed substrates;

FIG. 2 a further embodiment of an example of a system of two pre-fixed substrates;

FIG. 3 a further embodiment of a system of two pre-fixed substrates; and

FIG. 4 a perspective view of an example of a system of two pre-fixed substrates.

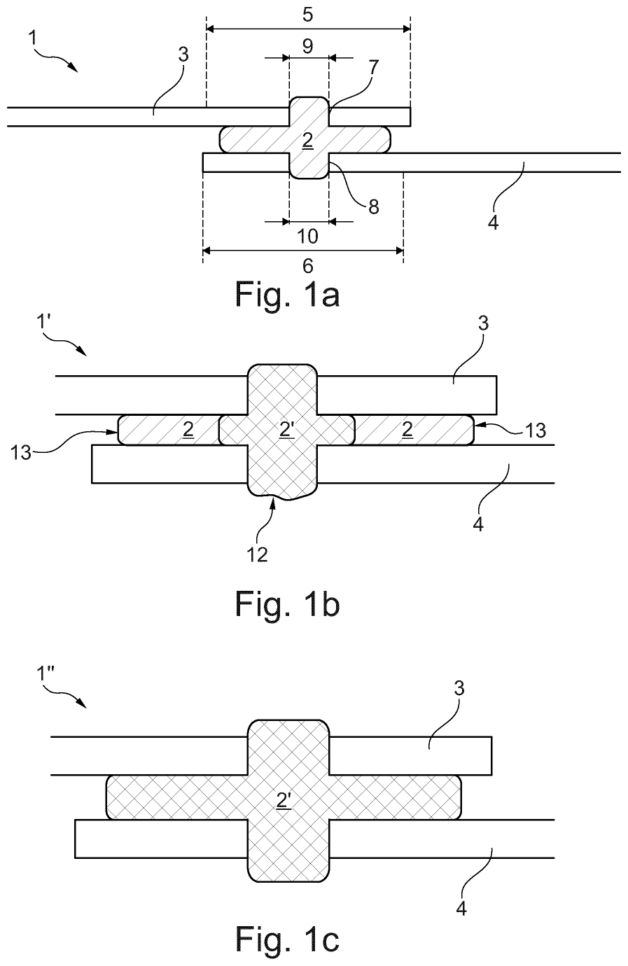

FIG. 1a to 1c show, by way of example and in schematic form, a first exemplary embodiment of a system 1, 1′, 1″ of two pre-fixed substrates 3, 4. FIG. 1a shows the non-pre-fixed system 1, FIG. 1b shows the pre-fixed system 1′, and FIG. 1c shows the secured system 1″.

The first substrate 3 has a first overlap region 5 in which a first opening 7 is arranged. The second substrate 4 has a second overlap region 6 in which a second opening 8 is arranged. The substrates 3, 4 are so positioned relative to one another that the respective overlap regions 5, 6 overlap completely. In this exemplary embodiment, the substrates 3, 4 are additionally so arranged relative to one another that the first opening 7 and the second opening 8 also overlap. The first opening 7 has a diameter 9 and the second opening 8 has a diameter 10, wherein the diameters 9, 10 of the openings 7, 8 are in each case measured on a side of the substrate 3, 4 that is remote from the respective other substrate 3, 4.

In the non-pre-fixed system 1, which is shown in FIG. 1a, the adhesive 2 is present in the completely uncured state.

In the pre-fixed system 1′, which is depicted in FIG. 1b, the adhesive 2 is present partly in the form of uncured adhesive 2 and partly in the form of cured adhesive 2′. In this case, the adhesive is cured in a first sub-region 12 and uncured in a second sub-region 13. This first sub-region 12 with the cured adhesive 2′ extends from the first opening 7 of the first substrate 3 into the second opening 8 of the second substrate 4. A kind of pin or stud of cured adhesive 2′ is thereby formed, which secures the substrates 3, 4 against displacement. In this exemplary embodiment, the entire cross section at the level of the openings 7, 8 is not cured. In alternative exemplary embodiments, however, the entire cross section at the level of the openings 7, 8 can also be cured, wherein the uncured second sub-region 12 then comes to lie further away from the openings 7, 8 and therefore would not be visible in such a cross-sectional view.

Finally, in the secured system 1″, shown in FIG. 1c, the adhesive 2′ is present completely in the form of cured adhesive. This state is present, for example, after treatment of the system in a painting oven.

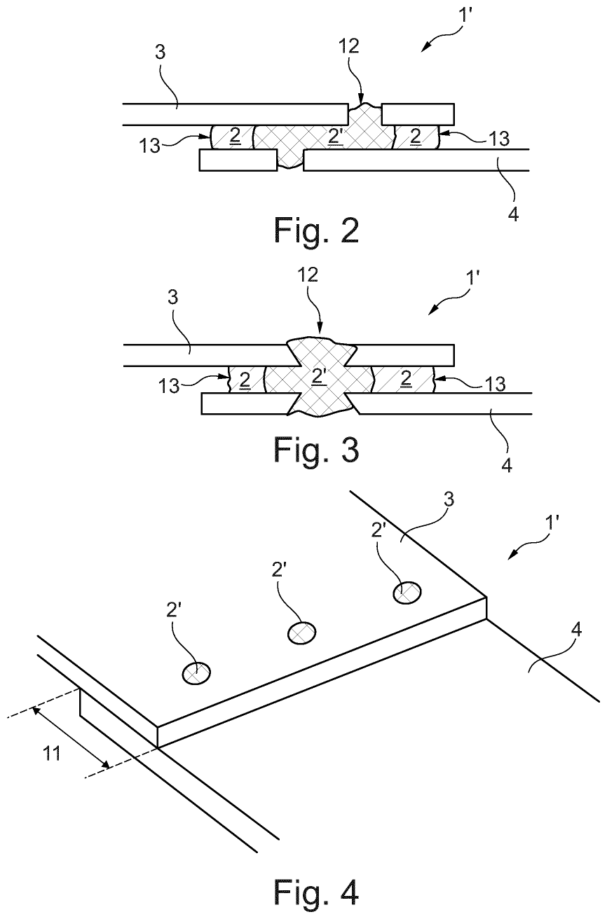

FIG. 2 shows a further exemplary embodiment of a pre-fixed system P. In contrast to the system 1′ in FIG. 1b, in this exemplary embodiment according to FIG. 2 the openings 7 and 8 of the substrates 3, 4 are not arranged congruently or overlapping. Thus, the first sub-region 12 with the cured adhesive 2′ does not form an I-shaped anchoring, but rather a Z-shaped sub-region 12 is formed.

In addition, the openings in this example are filled not completely but only partly with adhesive 2, 2′.

FIG. 3 shows, schematically, a further exemplary embodiment, wherein the pre-fixed system 1′ has openings with an undercut. In this case, the undercut is so configured that the openings are each larger on a side remote from the adhesive 2, 2′ than on a side facing the adhesive 2, 2′, so that the openings taper toward the side facing the adhesive 2, 2′. As a result, additional anchoring of the first sub-region 12 with the cured adhesive 2′ in the respective substrates 3, 4 is obtained.

Finally, FIG. 4 shows a spatial representation of a pre-fixed system 1′. In this case, it can be seen that the first substrate 3 and the second substrate 4 overlap, wherein in each case openings are arranged in this overlap region. The overlap region additionally has a width 11. In this exemplary embodiment, the substrates 3, 4 each comprise three openings, wherein an opening of the first substrate 3 is in each case associated with an opening of the second substrate 4. In this exemplary embodiment, the openings are in each case equally spaced apart from an edge of the substrates 3, 4.

Table 1 below illustrates a test arrangement with which an effect in terms of tensile-shear strength of the system proposed here was tested. The tensile-shear strength was measured in MPa, in each case in three different substrate types (without an opening; with an opening having a diameter of 2 mm; with an opening having a diameter of 4 mm) and in each case at three different temperatures (at 23° C.; at 80° C.; at 180° C.). The adhesive used was SikaPower®-497. The substrates used were steel substrates of dimensions 100×25×1.2 mm. The substrates were oiled with Anticorit PL3802-39S, 3 g/m². The adhesive surfaces were in each case 25×10×0.3 mm. The pulling rate was 10 mm/min. The adhesive was in each case pre-cured for 35 minutes at 175° C.

TABLE 1
Tensile-shear strength in MPa of different substrates
at different temperatures

| | | Opening with | Opening with |
|---|---|---|---|
| Temperature | No opening | 2 mm diameter | 4 mm diameter |
| 23° C. | 30.4 ± 0.4 | 30.3 ± 0.4 | 30.8 ± 0.8 |
| 80° C. | 20.6 ± 0.1 | 21.2 ± 1.0 | 20.7 ± 0.9 |
| 180° C. | 1.9 ± 0.2 | 2.3 ± 0.2 | 2.9 ± 0.2 |

It is apparent from this test that the substrates having openings in which the adhesive forms a cured pin between the openings have better high-temperature adhesion (see values at 180° C.) than the substrates without openings. At lower temperatures (see values at 23° C. and 80° C.), such an effect is less great or not pronounced.

### LIST OF REFERENCE NUMERALS

1 non-pre-fixed system
1′ pre-fixed system
1″ secured system
2 uncured adhesive
2′ cured adhesive
3 first substrate
4 second substrate
5 first overlap region
6 second overlap region
7 first opening
8 second opening
9 diameter of the first opening
10 diameter of the second opening
11 width of the overlap regions
12 first sub-region of the adhesive
13 second sub-region of the adhesive

1. A system of two pre-fixed substrates, the system comprising:
a first substrate having a first opening in a first overlap region;
a second substrate having a second opening in a second overlap region; and
an adhesive which is arranged between the overlap regions of the first substrate and of the second substrate, wherein the adhesive both bonds the substrates together and is arranged at least partly in the openings;
wherein the adhesive is locally cured in a region of the openings, wherein a cured first sub-region of the adhesive extends from the first opening into the second opening and wherein a second sub-region of the adhesive is uncured.

2. The system as claimed in claim 1, wherein the first opening and the second opening are arranged so that they overlap at least partly.

3. The system as claimed in claim 1, wherein the width of the overlap regions is from 5 mm to 40 mm.

4. The system as claimed in claim 1, wherein the maximum diameter of the openings, measured at a surface of the substrates that in each case faces away from the other substrate, is from 1 mm to 20 mm and/or is from 20 to 80% of the width of the overlap regions.

5. The system as claimed in claim 1, wherein at least one opening an undercut, and wherein the opening tapers toward a side of the substrate that faces toward the adhesive.

6. The system as claimed in claim 1, wherein the adhesive fills at least one opening completely and/or wherein the adhesive extends beyond the opening at a surface of at least one substrate that faces away from the other substrate.

7. The system as claimed in claim 1, wherein the first cured sub-region of the adhesive amounts to not more than 30% of the total adhesive.

8. The system as claimed in claim 1, wherein the substrates each have a plurality of openings, wherein an opening in the first substrate is in each case associated with an opening in the second substrate.

9. The system as claimed in claim 1, wherein the adhesive is a one-component epoxy-based or polyurethane-based adhesive.

10. The system as claimed in claim 1, wherein the substrates are formed of sheet steel and/or of aluminum sheet and/or of carbon.

11. The system as claimed in claim 1, wherein the substrates are parts of a body.

12. A method for pre-fixing two substrates, the method comprising the steps of:
providing a first substrate having a first opening in a first overlap region, a second substrate having a second opening in a second overlap region, and an adhesive,
arranging the adhesive between the overlap regions of the first substrate and of the second substrate so that the adhesive both bonds the substrates and is arranged at least partly in the openings; and
locally curing the adhesive in a region of the openings so that a cured first sub-region of the adhesive is formed which extends from the first opening into the second opening, wherein a second sub-region of the adhesive remains uncured.

13. The method as claimed in claim 12, wherein, during the arrangement of the adhesive, the adhesive is first arranged on an overlap region of one substrate and then the other substrate is arranged with its overlap region on the adhesive, and then the two substrates are moved toward one another so that the adhesive is pressed at least partly into the openings.

14. The method as claimed in claim 12, wherein heat or radiation is applied in the region of the openings during the local curing.

15. The method as claimed in claim 12, wherein the method is carried out using a system of two pre-fixed substrates, the system comprising:
the first substrate having the first opening in the first overlap region;
the second substrate having the second opening in the second overlap region; and
the adhesive which is arranged between the overlap regions of the first substrate and of the second substrate wherein the adhesive both bonds the substrates together and is arranged at least partly in the openings;
wherein the adhesive is locally cured in the region of the openings, wherein the cured first sub-region of the adhesive extends from the first opening into the second opening and wherein the second sub-region of the adhesive is uncured.
